(19) United States
(12) Patent Application Publication
(10) Pub. No.: US 2004/0256118 A1
(43) Pub. Date: Dec. 23, 2004

(54) Fire extinguisher discharge method and apparatus

(75) Inventors: Robert George Dunster, Slough (GB); Simon John Davies, Staines (GB); Robert James Lade, Marlow (GB); Kurt D. Lovell, Bellingham, MA (US)

Correspondence Address: MERCHANT & GOULD PC, P.O. BOX 2903, MINNEAPOLIS, MN, 55402-0903, US

(73) Assignees: KIDDE-FENWAL INC., ASHLAND, MA; KIDDE IP HOLDINGS LIMITED, COLNBROOK (GB)

(21) Appl. No.: 10/822,190

(22) Filed: Apr. 8, 2004

(30) Foreign Application Priority Data
Nov. 28, 2002 (GB) 0227819.0

(51) Int. Cl. A62C 37/08

(52) U.S. Cl. 169/54

(57) ABSTRACT

A nozzle has a body with a central cavity from which a plurality of fire extinguishant fluid outlets extend. The outlets extend non-radially with respect to the central axis of the cavity, i.e. at least a portion of each outlet is inclined with respect to any plane parallel to and passing through the central axis of the cavity which intersects the portion of the outlet. The extinguishant from the non-radial outlets is thrown towards the walls of the chamber, along the paths. The jets of the fluid induce a rotational movement within the ambient fluid (for example, air) already present in the chamber, thus creating a vortex or rotational movement of the fluid within the chamber. In another embodiment, the vortex or rotational movement is generated by a nozzle assembly of generally cruciform configuration with three or more discharge tubes having outlets formed therein for discharging extinguishant in equi-angularly-spaced directions.

### FIELD OF THE INVENTION

This invention relates to a fire extinguishing system, a fire extinguishing spray nozzle, a chamber having a fire extinguishing spray nozzle mounted therein and a method of fire extinguishing.

### BACKGROUND OF THE INVENTION

A prior art extinguishing nozzle design is shown in FIGS. 1, 2 and 3, which will be discussed in more detail below. Such conventional nozzle designs have a plurality of fluid outlets which allow extinguishant to pass from the central cavity of the nozzle to a chamber in which a fire exists in order to extinguish the fire. Each of the outlets extends radially from the central axis of the cavity. While such arrangements have been found to be effective, their effectiveness is reduced when the fire lies behind an obstruction which is in the path of a radius extending from the central axis of the cavity.

The embodiments of the present invention, to be described in detail below, by way of example only, seek to provide improved extinguishing performance in such situations.

Other extinguishing nozzle arrangements are disclosed in EP0671217, EP0385851, U.S. Pat. No. 6,129,154, U.S. Pat No. 568,376 and SU 1276344.

### SUMMARY OF THE INVENTION

According to a first aspect of the present invention, there is provided a fire extinguishing system including a nozzle having a cavity, and at least one extinguishant outlet for discharging extinguishant from the cavity into a fluid-filled volume, which outlet is fixed in use, the arrangement being such that a rotational movement of the fluid, including the extinguishant, within the volume is induced.

According to a second aspect of the present invention, there is provided a fire extinguishing spray nozzle having a cavity and at least one outlet for discharging extinguishant from the cavity, at least a portion of the outlet being inclined with respect to any plane which is parallel to and passes through the central axis of the cavity and which intersects the portion of the or each outlet.

According to a third aspect of the present invention, there is provided a chamber containing fluid, such as air, having a fire extinguishing spray nozzle mounted therein, which nozzle is fixed in use, the arrangement being such that, in use, the extinguishant emitted from the nozzle and the fluid within the chamber turns angularly about the nozzle.

According to a fourth aspect of the present invention, there is provided a fire extinguishing system including means for supplying a pressurised extinguishant, a nozzle having a cavity for receiving the extinguishant and having at least one outlet for expelling the extinguishant, in use the arrangement being such that at the entrance to the or each outlet, the extinguishant travels generally radially with respect to the central axis of the cavity, and such that the configuration of the outlet deviates the path of the fire extinguishant from the radial direction so that when the extinguishant exits the outlet it travels in a non-radial direction.

According to a fifth aspect of the present invention, there is provided a method of fire extinguishing including emitting a plurality of jets extinguishant into a fluid-filled chamber from a fixed nozzle such that when the jets of extinguishant meet the walls of the chamber they induce a rotational movement in the fluid, including the extinguishant, within the chamber.

According to a sixth aspect of the present invention, there is provided a method of fire extinguishing including emitting a plurality of jets extinguishant into a fluid-filled chamber from a fixed nozzle such that rotational movement in the fluid, including the extinguishant, is induced within the chamber.

### BRIEF DESCRIPTION OF THE DRAWINGS

Fire extinguishing systems, fire extinguishing spray nozzles, the chamber having a fire extinguisher spray nozzle mounted therein and a method of fire extinguishing will now be described, by way of example, with reference to the accompanying diagrammatic drawings in which:

FIG. 1 shows a side elevation of a conventional fire extinguishant spray nozzle;

FIG. 2 shows a cross-section taken along the line A-A of FIG. 1;

FIG. 3 shows the paths of the extinguishant jets expelled from the nozzle of FIGS. 1 and 2;

FIG. 4 shows a longitudinal cross-section taken through a nozzle according to a first embodiment to the present invention;

FIG. 5 shows a cross-section taken along the line B-B of FIG. 4;

FIG. 6 shows the paths and flow of extinguishant jets emitted from the nozzle of the first embodiment;

FIG. 7 shows a transverse cross-section through a nozzle illustrating a scheme for forming a non-radial outlet in accordance with the present invention;

FIG. 8 shows a longitudinal cross-section of a nozzle according to a second embodiment of the present invention;

FIG. 9 shows a cross-section taken along the line C-C of FIG. 8;

FIG. 10 shows a longitudinal cross-section of a nozzle of a third embodiment of the present invention;

FIG. 11 shows a cross-section taken along the line D-D of FIG. 10;

FIG. 12 shows a partial transverse cross-section through a nozzle having an alternative configuration of outlet nozzle in accordance with the present invention; and

FIG. 13 shows an overhead plan view of an extinguishant outlet arrangement of a further embodiment of the invention;

FIG. 14 shows a side elevation of the arrangement of FIG. 13; and

FIG. 15 shows a cross-section taken along the line E-E of FIG. 13.

### DETAILED DESCRIPTION

In general in FIGS. 1 to 12, like elements of different embodiments appearing in the Figures are designated with reference numerals differing in value by 100.

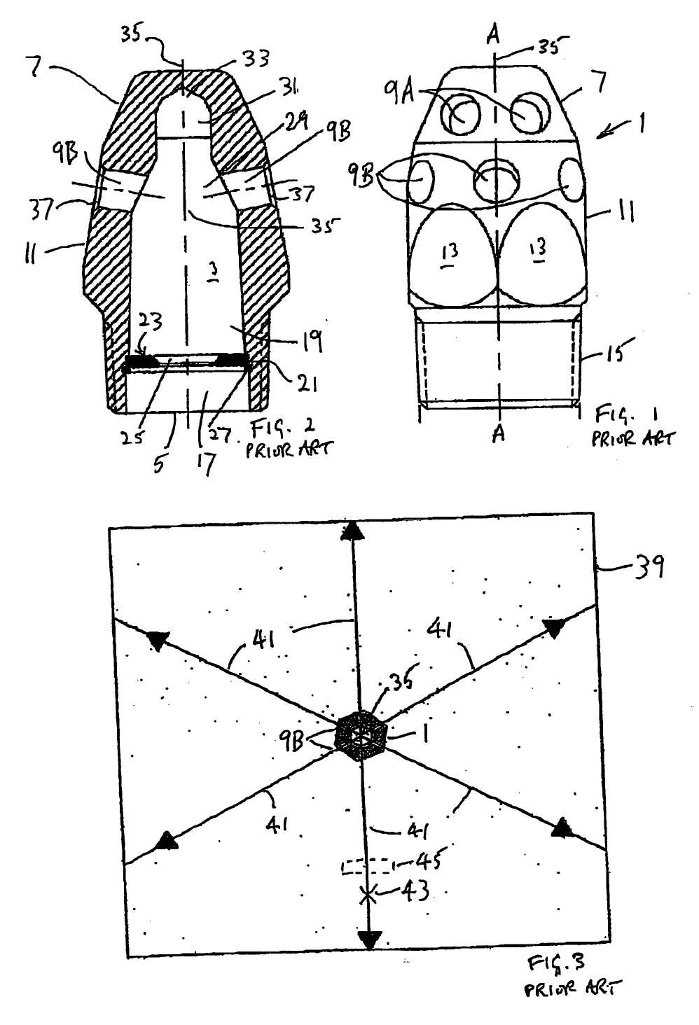

FIGS. 1 to 3 show the construction and operation of a prior art nozzle, which is described here to assist in the understanding of the present invention. The known nozzle has a generally cylindrical main body 1 formed of any suitable material, such as brass or another metal with the desired characteristics. The body has a cavity 3 formed in it with an open end 5. The upper portion 7 (in FIGS. 1 and 2) of the body 1, in which the closed end of the cavity 3 is located, has a frusto-conical exterior surface in which six equi-spaced outlets 9A are located (only two of the outlets being shown in FIG. 1). The mid-portion 11 of the body 1, at an upper region thereof, has six equi-spaced outlets 9B formed therein (only three of which can be seen in FIG. 1). The lower region of the mid-portion 11 has a hexagonal outer surface formed by six equally sized and spaced planar surfaces 13 which are configured to co-operate with a suitably sized spanner for allowing the nozzle to be mounted and dismounted to a pipe (not shown) providing a supply of extinguishant fluid, when such mounting is provided by co-operating screw threads (not shown). If such a screw thread is provided to the body 1 this may be provided at the base portion 15 thereof.

The cavity 3 at the portion 17 nearest the open end 5 is cylindrical. The next portion 19 of the cavity 3 has a smaller diameter than the lower portion 17 at the point where the portions 17 and 19 meet, thereby forming a shoulder 21 which locates a washer-like member 23 comprising a circular orifice 25 and a snap ring 27. Thereafter, the cavity 3 tapers inwardly. Where the outlets 9B meet the cavity 3, at region 29, the rate of the inward taper of the cavity 3 increases. The upper portion 31 of the cavity 3 comprises a cylindrical portion from which the outlets 9A extend and terminates in a closed conical portion 33.

The outlets 9A, 9B are inclined with respect to a plane perpendicular to the central axis 35 of the cavity 3 so that, when deployed for example on the ceiling or floor of a room or other chamber, the extinguishant is not discharged on to the ceiling or floor. Such outlets are said to have a “down-angle” when deployed on a ceiling. Where the outlets 9A, 9B meet the external wall of the body 1 an enlarged diameter portion 37 is optionally formed.

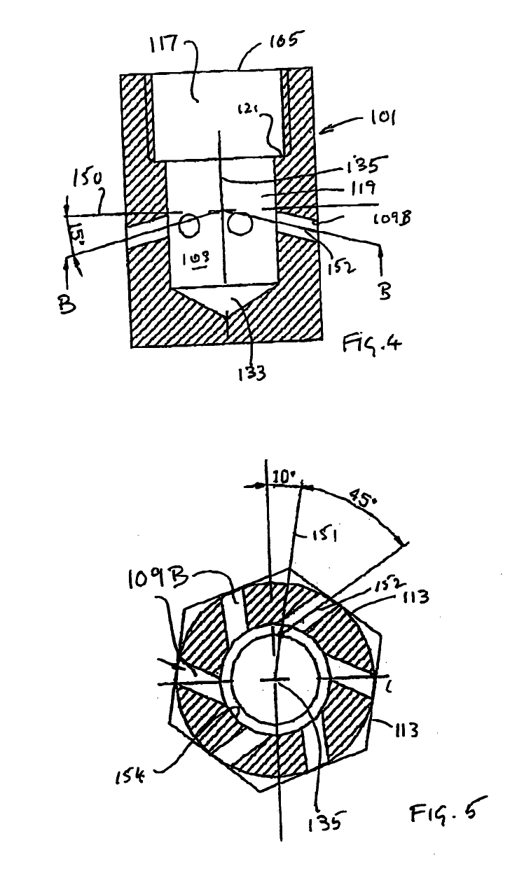

FIG. 3 shows schematically the nozzle located centrally within a room or other chamber 39, where it is mounted on the ceiling and does not move in use. The extinguishant supplied under pressure from the supply pipe passes into the cavity 3 and through the nozzle orifice 25, whereafter it is expelled through the outlets 9A, 9B. Each of the outlets 9A, 9B causes the formation of a jet of extinguishant as the extinguishant passes therethrough. The paths that these jets of extinguishant from the nozzles 9B will follow within the chamber 39 are indicated by lines 41. The fluid within the jets disperses as the jets pass through the fluid already within the chamber 39 (such as air) but will follow a path generally indicated by the lines 41.

Although the prior art nozzle is effective, it has been found that there can be a delay in extinguishing a fire which has, for example, a source 43 at a location within the chamber 39 where an obstruction 45 lies in the path of a radius extending from the central axis 35 of the nozzle to the fire source 43.

The delay in extinguishing the fire source 43 is caused because it takes some time for the extinguishant which is dispensed from the nozzle along fixed radial paths 41 to disperse within the chamber 39 and reach the fire source 43.

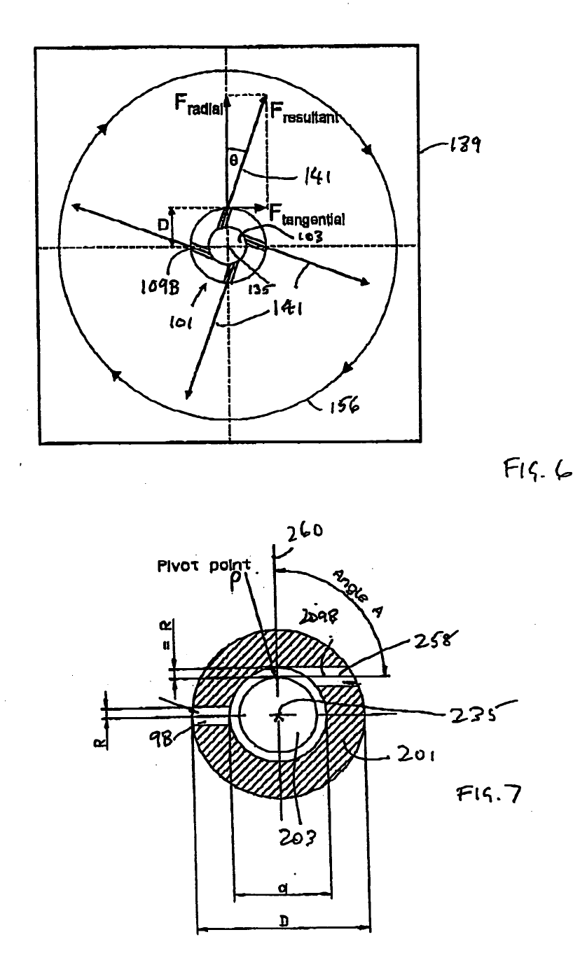

FIGS. 4 and 5 show, respectively, a longitudinal and a transverse cross-section of the body 101 of a nozzle according to a first embodiment of the invention. The portion 117 of the cavity 103 nearest the open end 105 of the nozzle is cylindrical and forms a shoulder 121 where it meets the middle portion 119. The shoulder 121 may locate a washer-like assembly (not shown) similar to the washer assembly 23 shown in FIG. 2, or fluid restriction may be caused by providing the middle portion 119 with an appropriate diameter. The middle portion 119 of the cavity 103 is, in this example, cylindrical. The closed portion 133 of the cavity 3 is conical. The nozzles 109B are inclined by 15° to a plane 150 lying perpendicular to the central axis 135 of the cavity 3. In this embodiment, additional nozzles corresponding to the nozzles 9A of the prior art are not provided, although they could be provided if desired.

As can be seen in FIG. 5, each outlet 109B is inclined (in this example by 45°) with respect to a plane 151 which is parallel to and extends through the central axis 135 of the cavity 3 and which intersects the outlet. This inclination is in addition to the 15° “down-angle” inclination provided with respect to the plane 150 shown in FIG. 4. It should be understood that 15° “down-angle” inclination may be omitted if desired.

Whether or not the down-angle inclination is provided, the outlets 109B are inclined with respect to any plane parallel to and passing through the central axis 135 of the cavity 103 which intersects the central axis 152 of the outlets.

In another words, the outlets 109B extend non-radially with respect to the central axis 135 of the chamber 3. The nozzles 109B can extend tangentially from the interior surface 154 of the chamber 3.

Although the central portion 119 from which the nozzles 109B extend is shown as being of circular cross-section, it should be understood that other shapes for this portion of the chamber could be used. It should also be appreciated that non-radial outlets 109B could be combined in a single nozzle with radial outlets, for example, having a configuration as shown in FIGS. 1, 2 and 3. The diameters (bore size) of the outlets may be equal, or different outlets may have different diameters. The amount of deviation of the non-radial outlets from a radius of the nozzle can vary between outlets provided on a single nozzle, as can the presence or degree of down-angles. The nozzles may also be unevenly spaced.

FIG. 6 shows a nozzle of the type illustrated in FIGS. 4 and 5 deployed in a room or chamber 139. However, for the sake of simplicity, only four outlets 109B are shown. The paths 141 of jets of extinguishant from the nozzle are shown. In a similar manner to the prior art illustrated in FIG. 3, the paths 141 of the extinguishant jets extend from the central region of the chamber 139 towards the walls of the chamber 139.

The inclination of the non-radial outlets 109B (with respect to any plane parallel to and passing through the central axis 135 of the cavity 103 which intersects the central axis 152 of the outlets) causes the extinguishant to apply a turning force to the nozzle as the extinguishant passes through the outlets 109B. The nozzle is fixed, so this turning force does not rotate the nozzle about the central axis 135.

If the effect of the “down-angle” is ignored (for the sake of simplicity), there are two forces acting on each outlet 109B during a discharge of extinguishant. The first is a radial force (F_{Radial}). The F_{Radial} vector (shown in FIG. 6) for each outlet 109B passes through the central vertical axis 135 of the nozzle and the centre of that outlet 109B. The magnitude of this vector is determined by the mass flux of the extinguishant as it exits the outlet 109B. The second force is the one responsible for applying a turning force to the nozzle. It is labelled F_{Tangential} and acts perpendicularly to F_{Radial}.

The resultant vector F_{Resultant} corresponds to the flow path 141 of the extinguishant.

F_{Tangential}=F_{Resultant} Sin(θ)

where “θ” represents the angle between the F_{Radial} and F_{Resultant} vectors. The torque about an outlet 109B is determined by the equation:

F_{Tangential} ×D=Torque about nozzle

where “D” represents the distance from the central axis 135 of the nozzle to the exit of the outlet 109B.

As mentioned above, the nozzle is fixed and is therefore prevented from turning. The radial and tangential forces are however both still present. The extinguishant from the non-radial outlets 109B is thrown towards the walls of the chamber 139, along the paths 141 shown in FIG. 6, much like the conventional radial nozzle described with reference to FIGS. 1 and 2. However, the jets of the fluid induce a rotational movement within the ambient fluid (for example, air) already present in the chamber. The force is additive and creates a vortex or rotational movement of the fluid within the chamber 139. The magnitude of this vortex depends on the force and angle of inclination of the combined jets of extinguishant from the nozzle, and the size and shape of the chamber 139. Structures within the chamber 139 will also affect the magnitude of rotation.

The extinguishant jets discharge with a linear motion from the nozzle outlets 109B to the walls of the chamber 139.

The overall effect of the nozzle of the first embodiment is to cause the fluid normally within the chamber 139, such as air, to rotate so that all the fluid within the chamber 139, including the extinguishant, swirls about the nozzle. This is highly advantageous in the event that the fire source is shielded from the nozzle by an obstruction in the manner illustrated in FIG. 3. The continuous movement of the fluid in the first embodiment results in the extinguishant reaching the fire source more quickly than when the prior art form of nozzle is employed. The nozzle itself does not move during extinguishing. The absence of moving parts means that the nozzle is reliable, relatively cheap to manufacture and is less prone to wear.

An extinguishant that rotates or turns angularly within the chamber 139 provides an efficient means of filling the free volume of the chamber. The main benefit, however, is the ability to distribute the extinguishant homogenously within a cluttered volume, such as when the chamber includes many obstructions to the extinguishant. Altering the degree of inclination of an outlet to the radius of the nozzle changes the velocity of rotation for a given extinguishant discharge.

As mentioned above, the inclination of a non-radial nozzle causes the extinguishant to apply a turning force to the nozzle as the extinguishant passes through the outlet. If the nozzle is attached to an extinguishant supply pipe by a screw thread, the direction of inclination and the direction of the screw thread should be selected such that the turning force tends to tighten the nozzle onto the extinguishant supply pipe.

Testing of the nozzle has been carried out in a UL/FM approved 100 m³ test chamber. First, and by way of comparison, a conventional nozzle having the form of that shown in FIGS. 1 and 2 was employed using nitrogen and water based extinguishant in an Argonite (RTM) extinguishing system. The mass of nitrogen required to extinguish 10 Class B heptane can fires was 31.7 kg (70 lbs). Then, a nozzle according to the first embodiment of the invention, as shown in FIGS. 4 and 5, was used with non-radial holes of 30°, 45°, 60° and 90° (tangential) with a 15° down angle. With the exception of the 90° variant, the 10 class B fires were successfully extinguished with 29 kg (64 lb) of nitrogen. This provided an 8.5% reduction in the mass of nitrogen used compared with a system using a conventional nozzle.

FIG. 7 shows a nozzle having a radial outlet 9B and a non-radial outlet 209B. The non-radial outlet 209B extends tangentially from the interior surface 254 of the cavity 203. The non-radial outlet can be described as follows. The nozzle body 201 has an external diameter D and an internal diameter d. The outlet 209B has a radius R and a central axis 258. A radius 260 extending from the central axis 235 of the nozzle body 201 intersects the central axis 258 of the outlet 209B at a □pivot point□ P. The angle A formed between the radius 260 extending from the central axis 235 of the chamber 203 through the pivot point P and the central axis 258 of the outlet 209B determines the angle of inclination of the non-radial outlet 209B. The outlet 209B can be provided with a down-angle if required.

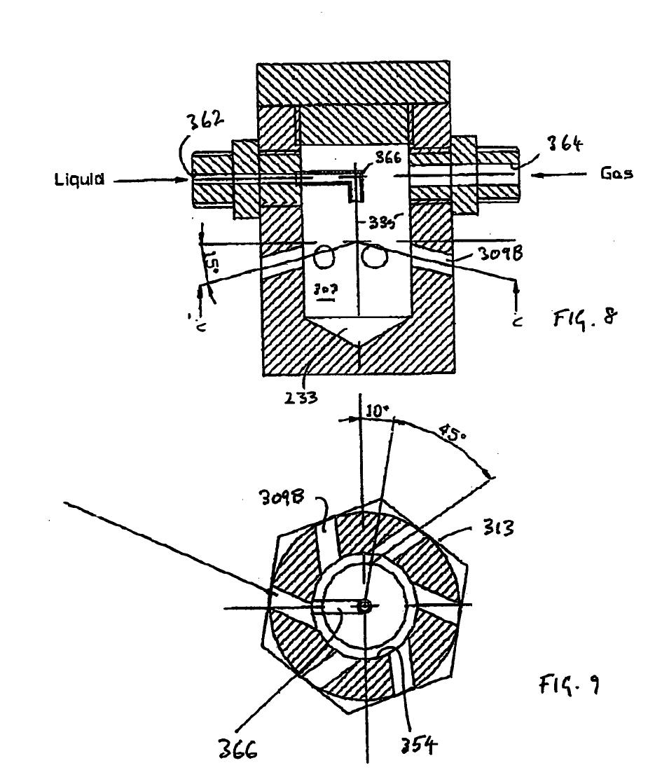

FIGS. 8 and 9 show, respectively, a longitudinal and a transverse cross-section of a nozzle according to a second embodiment of the present invention. In the second embodiment the outlets 309B are configured similarly to the first embodiment. However, rather than the extinguishant fluid being provided from an opening in the base of the nozzle, separate liquid 362 and gas 364 inlets are provided in the side wall of the nozzle body 301. A right angled pipe 366 extends from the liquid inlet 362 to expel liquid extinguishant at a point lying on the central axis 335 of the cavity 303. The liquid and gas provided into the cavity 303 mix and produce extinguishant which is expelled via outlets 309B. An example of a suitable liquid is water and a suitable gas is nitrogen.

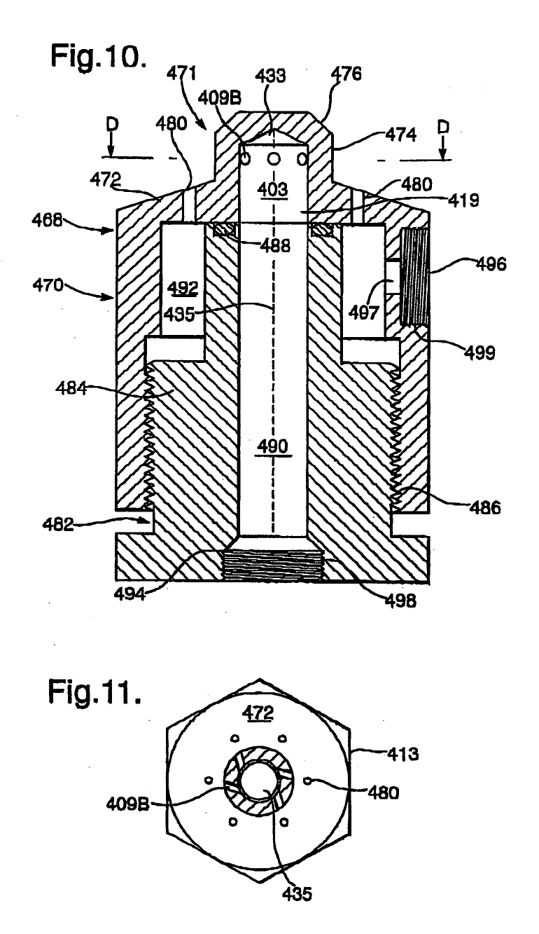

A further embodiment of the invention will now be described with reference to FIGS. 10 and 11. The nozzle of the third embodiment is in two parts. The outer body 468 comprises a cylindrical wall 470 having an integral end wall 471 comprising a frusto-conical portion 472, a cylindrical portion 474 and a further frusto-conical portion 476 within the end wall 471. These form a first cavity portion 433, corresponding to the cavity portion 133 of the FIG. 4 embodiment, and a second cavity portion 419 which is cylindrical and has outlets 409B extending therefrom through the cylindrical portion 474 in a similar manner to the first embodiment shown in FIG. 4. Like the embodiment of FIG. 4, six equi-spaced outlets 409B are provided which have an inclination with respect to a radius of the central axis 435 of the cavity 403. However, in this embodiment, the outlets 409B do not have a down-angle.

In the frusto-conical portion 472 of the end wall 471 six equi-spaced outlets 480 are provided which extend parallel to the central axis 435 of the cavity 403. The outlets 480 are positioned such that a fluid jet emitted therefrom will impinge on a respective one of the fluid jets emitted from the non-radial outlet 409B in the cylindrical wall 474. The relative positioning and configuration of the respective outlets 409B and 480 is shown in FIG. 11.

The inner body 482 comprises a generally cylindrical wall 484 which is externally threaded to engage an internal thread 486 formed at the lower end of the cylindrical wall 470 of the outer body. At its upper end (as viewed in FIG. 10) the inner body 482 includes an O-ring 488 which makes a gas and water-tight seal against the inner face of the end wall 471 of the outer body.

In this way, the inner and outer bodies 482, 468 define a central chamber 490 in communication with the outlets 409B and an annular chamber 492 in communication with the outlets 480.

Chamber 490 is connected to a connection port 494 which is formed to extend radially through the wall 470 of the outer part 468 and thence through a bore 497. Port 494 is internally threaded at 498 to enable it to be connected to a fluid supply pipe. Port 496 is internally threaded at 499 to enable it to be connected to a second fluid supply pipe.

In use, a suitable gas, such as air or nitrogen, is supplied through the fluid supply pipe connected to port 494 and exits under pressure in jets through outlets 409B. Simultaneously, water is supplied through port 496 from a separate pipe connected to the port, and exits in water jets through outlets 480. Because the exiting water jets are angled to the exiting air jets and aligned with them, impingement takes place, resulting in the transfer of kinetic energy and producing shearing of the water jets so as to convert the water into a rarified spray of fine drops which are carried forward by the remaining kinetic energy of the emerging jets. The various parameters of the emerging jets can be controlled by appropriate adjustment of the applied pressures and by the mutual angle of impingement of the air and water jets and the size of the jets so as to produce the desired water spray characteristics (drop size distribution, spray angle, throw of spray and type of spray e.g. with a void within it). The applied water pressure may lie within a range of say, 4 to 12 bar g while the applied gas pressure may be 4 bar g or less, again producing a consistent spray quality.

No mixing or jet impingement takes place inside the nozzle. Pressure and flow variations of one fluid therefore have no effect on the pressure-flow characteristics of the other. In addition, because the air and water are kept separate until their respective jets impinge outside the nozzle, there is no need to take any precaution to prevent the water supply from entering the air supply.

Instead of supplying air or gas to the port 494 and water to the port 496, these may be reversed: that is, the gas can be supplied to port 496 and the water to port 494. Alternatively, water can be supplied both to port 494 and to port 496.

As the jets of fluid from the outlets 409B and 480 meet, the resultant jet retains at least a portion of the angular momentum imparted by the non-radial outlets 409B in order that the resultant fluid jet has the same general characteristics as the fluid jets of the first and second embodiments, which rotate within the chamber.

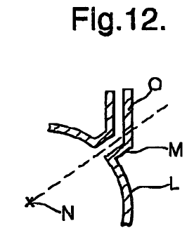

FIG. 12 shows an alternative arrangement of the nozzle that can be substituted for any of the nozzles 109B of the first embodiment, nozzles 309B of the second embodiment and nozzles 409B of the third embodiment. It will be noted that in the first, second and third embodiments, the outlets are formed by making a linear, circular cross-section hole through the wall of the nozzle body 101, 301, 470. In these embodiments, the outlets extend between the inner and outer surfaces of the nozzle body 101, 301, 470. In the arrangement shown in FIG. 12, however, the outlet is in the form of a tube extending from the nozzle body L. The tube comprises a first portion M which extends radially from the central axis N of the nozzle body L. The tube comprises a second section O which extends non-radially, and is inclined in the same manner as the outlets 109B, 309B, 409B of the first, second and third embodiments. The tube sections M and O may be formed as an integral unit. The tube itself may be formed integrally with the nozzle body L, or it may be attached to the nozzle body L by co-operating screw threads or any other suitable means.

The outlet arrangement shown in FIG. 12 will provide a similar effect to a nozzle formed between the inner and outer surfaces of the known outer walls of the nozzle body if the tube portion 0 is oriented in the same manner as the non-radial outlet between the inner and outer walls of the nozzle body.

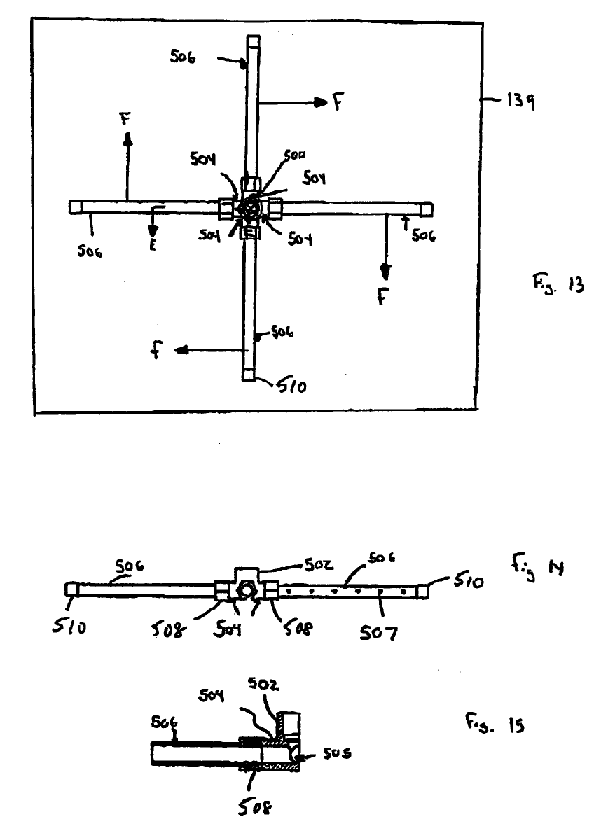

FIGS. 13 to 15 show a further alternative nozzle arrangement. A five-way fluid distribution block 500 has an integrally formed upwardly extending (in use) flange 502 of cylindrical configuration for connection to a supply of extinguishant. Typically, the distribution block 500 will be mounted to the ceiling of a chamber (similar to the chamber 139 of the previous embodiments) such that extinguishant fluid can be supplied thereto. Integrally extending from the distribution block 500 are four sideways-extending flanges 504, which are in fluid communication with each other and with cylindrical flange 500 by means of a common fluid passageway 505 formed in the distribution block 500. The flanges 504 are equi-spaced from one another at an angular separation of 90°.

A hollow, elongate, generally cylindrical discharge tube 506 extends from each of the flanges 504 such that the nozzle assembly has a generally cruciform shape. Each tube 506 is mounted to a respective flange 504 by a screw threaded nut 508. At the distal end of each tube 506, the tube is closed off by an end cap 510.

Each discharge tube 506 is provided with one or more orifices 512. The orifices 512 extend through each discharged tube 506 along a plane that extends through the centre of each of the tubes 506 and is also generally parallel to the ceiling of the chamber 139. All the orifices 512 extend in the same plane. The orifices 512 formed in each discharge tube 506 receive extinguishant fluid provided to the flange 502 which then passes through each of the flanges 504 and along the length of the discharged tube 506 until it reaches the or each orifice 512. The orifices 512 in the respective discharge tubes are arranged such that fluid is discharged in the direction of arrow F. The fluid discharged by the or each orifice 512 in each discharge tube 506 is discharged in a direction generally perpendicular to the direction of the fluid discharge by each of the adjacent discharge tubes 506 and in the opposite direction to the discharge tube 506 extending in the opposite direction.

In the embodiments shown each discharge tube 506 is provided with six equi-spaced orifices, all of which extend in the same direction. However, it should be understood that more or fewer orifices 512 could be provided in each discharge tube 506. Each discharge tube 506 may have a different number of orifices 512.

The nozzle arrangement shown in FIGS. 13 to 15 may be used to vaporise FM-200 (or any other suitable extinguishant) at low pressure, and distributes the vapour evenly throughout the chamber 139 in a circular or vortex motion. The orifices 512 are arranged to promote rapid flashing of the extinguishant agent (i.e. at a minimum distance from the point of discharge). Orifice 512 size, edge geometry and spacing in the embodiments shown may be optimised to produce vaporisation within 150 mm (six inches) of the discharge tube at a discharge pressure of 18 PSI.

Jets of fluid from the orifices 512 induce a rotational movement within the ambient fluid (for example, air) already present in the chamber 139. The force is additive and creates a vortex or rotational movement of the fluid within the chamber 139. The magnitude of this vortex depends on the force of the combined jets of extinguishant from the orifices 512, and the size and shape of the chamber 139. Structures within the chamber 139 will also affect the magnitude of rotation. The extinguishant jets discharge with a linear motion from the orifices 512 to the walls of the chamber 139.

The overall effect of the nozzle assembly of this embodiment is to cause fluid normally within the chamber 139, such as air, to rotate so that all the fluid within the chamber 139, including the extinguishant, swirls about the fixed nozzle assembly. This is highly advantageous in the event that the fire source is shielded from the nozzle by an obstruction in the manner illustrated in FIG. 3. The continuous movement of the fluid results in the extinguishant reaching the fire source quicker than when the prior art form of nozzle is employed. An extinguishant that rotates or turns angularly within the chamber 139 provides an efficient means of filling the free volume of the chamber. The main benefit, however, is the ability to distribute the extinguishant homogenously within a cluttered volume, such as when the chamber includes many obstructions to the extinguishant.

FIGS. 13 to 15 show four discharge tubes. It should be understood that there may be more or fewer discharge tubes than this (with a corresponding number of flanges 504). For example, there could be three discharge tubes, or as many as can feasibly be formed by the manufacturing process of the nozzle arrangement. However many discharge tubes are provided, the discharge tubes should preferably be angularly equi-spaced from one another. For example, if three discharge tubes are employed, the discharge tubes would be spaced apart by 120°, and if five discharge tubes were provided, they would be spaced apart by 72° etc.

As in the embodiment illustrated in FIGS. 13 to 15, each orifice 507 extends in, and the fluid discharged by the or each orifice 507 in each discharge tube 506 is discharged in, a direction tangential to an imaginary circle lying in the same plane as all of the discharge tubes. The angle between each tangent line and the adjacent part of the circle is substantially identical. The angle formed between adjacent tangent lines is the same as the angle between the associated adjacent discharge tubes. Each tangent line extends in the same direction with respect to the circle.

1. A fire extinguishing system including a nozzle having a cavity, and at least one extinguishant outlet for discharging extinguishant from the cavity into a fluid-filled volume, which outlet is fixed in use, the arrangement being such that a rotational movement of the fluid, including the extinguishant, within the volume is induced.

2. A system according to claim 1, wherein at least a portion of the or each outlet is inclined with respect to any plane which is parallel to and passes through the central axis of the cavity and which intersects the portion of the or each outlet.

3. A system according to claim 1, wherein a plane which lies parallel to the central axis of the cavity and extends along the central axis of at least a portion of the or each outlet is inclined with respect to the interior wall of the cavity at the region where the outlet meets the interior wall.

4. A system according to claim 1, wherein the or each outlet extends tangentially from the interior wall of the cavity.

5. A system according to claim 1, in which the direction of flow of the extinguishant in the cavity towards the outlet is aligned with an axis of symmetry of the cavity and in which the axis of at least the distal portion of the outlet does not intersect that axis of symmetry.

6. A system according to claim 1, wherein the or each outlet includes a portion which extends radially with respect to the central axis of the cavity.

7. A system according to claim 1, wherein a plurality of outlets are provided, each having a portion with a different inclination with respect to a radius extending from the central axis of the cavity.

8. A system according to claim 1, wherein the or each outlet is inclined with respect to a plane perpendicular to the central axis of the cavity.

9. A system according to claim 1, wherein the nozzle comprises a hollow tube having one or more of said outlets formed therein.

10. A system according to claim 9, wherein the nozzle comprises a plurality of said tubes.

11. A system according to claim 10, wherein each of said tubes is coupled together at one end thereof for fluid communication with a supply of the extinguishant.

12. A system according to claim 11, wherein each of said tubes is generally linear and is spaced from each of said tubes adjacent thereto by a substantially equal predetermined angle.

13. A system according to claim 10, wherein the nozzle comprises three or more of said tubes.

14. A system according to claim 8, wherein a plurality of said outlets are formed in said tube.

15. A system according to claim 14, wherein said outlets are equi-spaced.

16. A fire extinguishing spray nozzle having a cavity and at least one outlet for discharging extinguishant from the cavity, at least a portion of the outlet being inclined with respect to any plane which is parallel to and passes through the central axis of the cavity and which intersects the portion of the or each outlet.

17. A chamber containing fluid, such as air, having a fire extinguishing spray nozzle mounted therein, which nozzle is fixed in use, the arrangement being such that, in use, the extinguishant emitted from the nozzle and the fluid within the chamber turns angularly about the nozzle.

18. A fire extinguishing system including means for supplying a pressurised extinguishant, a nozzle having a cavity for receiving the extinguishant and having at least one outlet for expelling the extinguishant, in use the arrangement being such that at the entrance to the or each outlet, the extinguishant travels generally radially with respect to the central axis of the cavity, and such that the configuration of the outlet deviates the path of the fire extinguishant from the radial direction so that when the extinguishant exits the outlet it travels in a non-radial direction.

19. A method of fire extinguishing including emitting a plurality of jets extinguishant into a fluid-filled chamber from a fixed nozzle such that when the jets of extinguishant meet the walls of the chamber they induce a rotational movement in the fluid, including the extinguishant, within the chamber.

20. A method according to claim 19, wherein the extinguishant fluid emitted from the nozzle has its path deviated as it passes through the outlets of the nozzle so as to alter the angular momentum of the fluid within the jets.

21. A method of fire extinguishing including emitting a plurality of jets extinguishant into a fluid-filled chamber from a fixed nozzle such that rotational movement in the fluid, including the extinguishant, is induced within the chamber.
